(19) United States
(12) Patent Application Publication
(10) Pub. No.: US 2019/0204630 A1
(43) Pub. Date: Jul. 4, 2019

(54) TEST DEVICE AND TEST METHOD FOR DISPLAY PANEL

(71) Applicants: HKC Corporation Limited, Shenzhen (CN); Chongqing HKC Optoelectronics Technology Co., Ltd., Chongqing (CN)

(72) Inventor: YU-JEN CHEN, Chongqing (CN)

(21) Appl. No.: 16/325,736

(22) PCT Filed: May 26, 2017
(86) PCT No.: PCT/CN2017/086142

§ 371 Date: Feb. 15, 2019

(30) Foreign Application Priority Data
Apr. 5, 2017 (CN) 201710227131.7

(51) Int. Cl. G02F 1/13; G09G 3/00; G02F 1/1335

(52) U.S. Cl. CPC G02F 1/1309; G02F 1/133514; G09G 3/006

(57) ABSTRACT

The present application discloses a test device and test method for a display panel, the display panel including color filters including a plurality of row color filters and at least twelve column color filters, the test device including scanning lines and data lines, the scanning lines are used to be connected to the row color filters, the scanning lines include first scanning lines and second scanning lines, and the first scanning lines and the second scanning lines are respectively connected to the row color filters alternately; and the data lines are used to be connected to the column color filters, a number of the data lines is at least twelve, and each data line is connected to one column color filter.

### TECHNICAL FIELD

The present application relates to the technical field of display, and more particularly to a test device and test method for a display panel.

### BACKGROUND

Liquid crystal display apparatuses have numerous advantages, such as a thin body, power savings, no radiation, etc. and are widely used. Most liquid crystal display apparatuses in the current market are backlit liquid crystal display apparatuses, each including a liquid crystal panel and a backlight module. Working principle of the liquid crystal panel is that liquid crystals are put in two parallel glass substrates, and a driving voltage is applied to the two glass substrates to control rotation of the liquid crystals, to refract light rays of the backlight module to generate a picture.

Thin film transistor-liquid crystal display apparatuses (TFT-LCD) currently maintain a leading status in the display field because of low power consumption, excellent picture quality, high production yield, and other properties. Similarly, the thin film transistor-liquid crystal display apparatus includes a liquid crystal panel and a backlight module. The liquid crystal panel includes a color filter substrate (CF substrate) and a thin film transistor substrate (TFT substrate), and transparent electrodes on relative inner sides of the above substrates. A layer of liquid crystals (LC) is positioned between two substrates. The liquid crystal panel changes a polarized state of light by controlling the direction of the LCs through an electric field, and realizes penetration and obstruction of a light path via a polarized plate, so as to realize the purpose of display.

The thin film transistor array substrate includes a pixel structure. The existing pixel structure uses a three-color technology, specifically, red, green, blue (RGB) technology, and a four-color technology, specifically, white, red, green, blue (WRGB) technology. Because of having the advantages of relatively high penetration rate and reduction of color difference, the four-color technology is widely used.

The existing four-color technology is formed by improving the three-color technology in general. By improving the three-color technology into the four-color technology, in the panel test process, the same manner of connecting lines is used in general. Specifically, as shown in FIG. 1 to FIG. 4, two scanning lines (G1, G2) and three data lines (S1, S2, S3) are respectively used. In the four-color technology, as shown in FIG. 2, each of the data lines (S1, S2, S3) is at least connected to two color filters, mixed colors are formed in the picture test process, and FIG. 3 and FIG. 4 respectively show pictures of two different mixed colors formed in FIG. 2. Blank portions in FIG. 3 and FIG. 1 represent mixed color portions. Thus, solid-color pictures of red (R), green (G), blue (B), yellow (Y), cyan (C), and purple (P) cannot be detected, causing undetected error during testing.

### SUMMARY

One aim of the present application is to provide a test device for a display panel which is not easy to form mixed colors in the picture test process to detect solid-color pictures of red (R), green (G), blue (B), yellow (Y), cyan (C) and purple (P), to reduce undetected error during testing.

The other aim of the present application is to provide a test method for a display panel, which is not easy to form mixed colors in the picture test process to detect solid-color pictures of red (R), green (G), blue (B), yellow (Y), cyan (C), and purple (P), to reduce undetected error during testing.

The aim of the present invention is realized by the following methods:

To solve the above problem, according to one aspect of the present application, the present application discloses a test device for a display panel, the display panel including color filters including a plurality of row color filters and at least twelve column color filters, the test device including: scanning lines, used to be connected to the row color filters, where the scanning lines include first scanning lines and second scanning lines, and the first scanning lines and the second scanning lines are respectively connected to the row color filters alternately; data lines, used to be connected to the column color filters, where a number of the data lines is at least twelve, and each data line is connected to one column color filter.

Optionally, a number of the data lines is twelve, a number of the column color filters is twelve, and the data lines are connected to the column color filters in a manner of one-to-one correspondence.

Optionally, the twelve column color filters are arranged in sequence, and the twelve column color filters are divided into three groups, each group of column color filters including four adjacent column color filters; and the twelve data lines are arranged in sequence, and the four column color filters in the same group of column color filters are connected to the data line in sequence at an interval of two data lines. This is one specific manner of connecting the data lines to the column color filters of the present application, and connecting in a grouping manner is less error prone and facilitates connecting operations.

Optionally, the twelve data lines are arranged in sequence, the twelve column color filters are arranged in sequence, and the twelve data lines are connected to the twelve column color filters in sequence from one end to the other end thereof, and from one side to the other side of the column color filters. This is another specific manner of connecting the data lines to the column color filters of the present application, and connecting in sequence facilitates connecting operations and is less error prone.

Optionally, a number of the column color filters is a common multiple of three and four, and a number of the data lines is the same as that of the column color filters.

Similarly, to solve the above problem, according to another aspect of the present application, the present application further discloses a test method for a display panel. The display panel include color filters including a plurality of row color filters and at least twelve column color filters. The test method includes:

Connecting scanning lines to the row color filters, where the scanning lines include first scanning lines and second scanning lines, and the first scanning lines and the second scanning lines are respectively connected to the row color filters alternately; and

Connecting data lines to the column color filters, where a number of the data lines is at least twelve, and each data line is connected to one column color filter.

Optionally, a number of the data lines is twelve, a number of the column color filters is twelve, and the data lines are connected to the column color filters in a manner of one-to-one correspondence.

Optionally, the twelve column color filters are arranged in sequence, and the twelve column color filters are divided into three groups, each group of column color filters including four adjacent column color filters; and the twelve data lines are arranged in sequence, and the four column color filters in the same group of column color filters are connected the data lines in sequence at an interval of two data lines. This is one specific manner of connecting the data lines to the column color filters of the present application, and connecting in a grouping manner is less error prone and facilitates connecting operations.

Optionally, the twelve data lines are arranged in sequence, the twelve column color filters are arranged in sequence, and the twelve data lines are connected to the twelve column color filters in sequence from one end to the other end thereof, and from one side to the other side of the column color filters. This is another specific manner of connecting the data lines to the column color filters of the present application, and connecting in sequence facilitates connecting operations and is less error prone.

Optionally, the color filters of the display panel to be tested of the present application include a plurality of row color filters and at least twelve column color filters. The scanning lines are connected to the row color filters to scan the row color filters. Specifically, the first scanning lines of the scanning lines scan the row color filters of the Nth row, N being greater than or equal to 1, and the second scanning lines of the scanning lines scan the row color filters of the N+1th row and are arranged in sequence. The data lines are connected to the column color filters to transmit signals to the column color filters. Specifically, a number of the data lines is at least twelve, and each data line is connected to one column color filter. That is to say, each data line is connected to one column color filter, and drives the column color filters of the column. Thus, it is guaranteed that one data line is only connected to one column color filter. The test device is not easy to form mixed colors in the picture test process to detect solid-color pictures of red (R), green (G), blue (B), yellow (Y), cyan (C), and purple (P), to reduce undetected error during testing.

### BRIEF DESCRIPTION OF DRAWINGS

The drawings included are used for providing further understanding of embodiments of the present application, constitute part of the description, are used for illustrating implementation manners of the present application, and interpret principles of the present application together with text description. Apparently, the drawings in the following description are merely some embodiments of the present application, and for those of ordinary skill in the art, other drawings can also be obtained according to the drawings without contributing creative labor. In the drawings:

FIG. 1 is a schematic diagram of RGB color filters respectively connected to data lines and scanning lines in a test picture in the exemplary technology.

FIG. 2 is a schematic diagram of WRGB color filters respectively connected to data lines and scanning lines in a test picture in the exemplary technology.

FIG. 3 shows one test picture formed in FIG. 2.

FIG. 4 shows another test picture formed in FIG. 2.

FIG. 5 is one structural schematic diagram of a test device connected to RGB color filters in an embodiment of the present application.

FIG. 6 is one structural schematic diagram of a test device connected to WRGB color filters in an embodiment of the present application.

FIG. 7 is another structural schematic diagram of a test device connected to RGB color filters in an embodiment of the present application.

FIG. 8 is another structural schematic diagram of a test device connected to WRGB color filters in an embodiment of the present application.

FIG. 9 is a schematic diagram of steps of a test method in an embodiment of the present application.

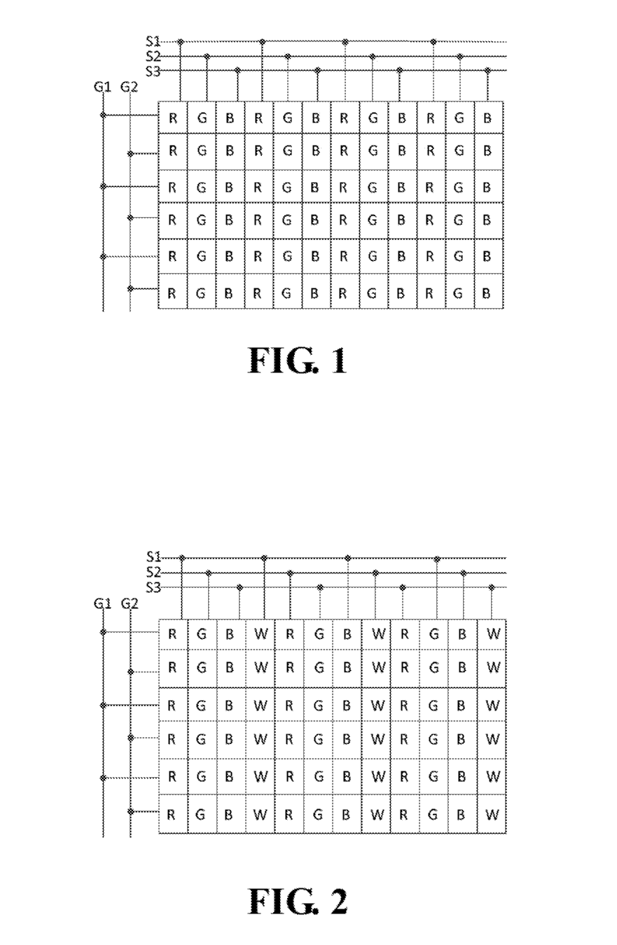

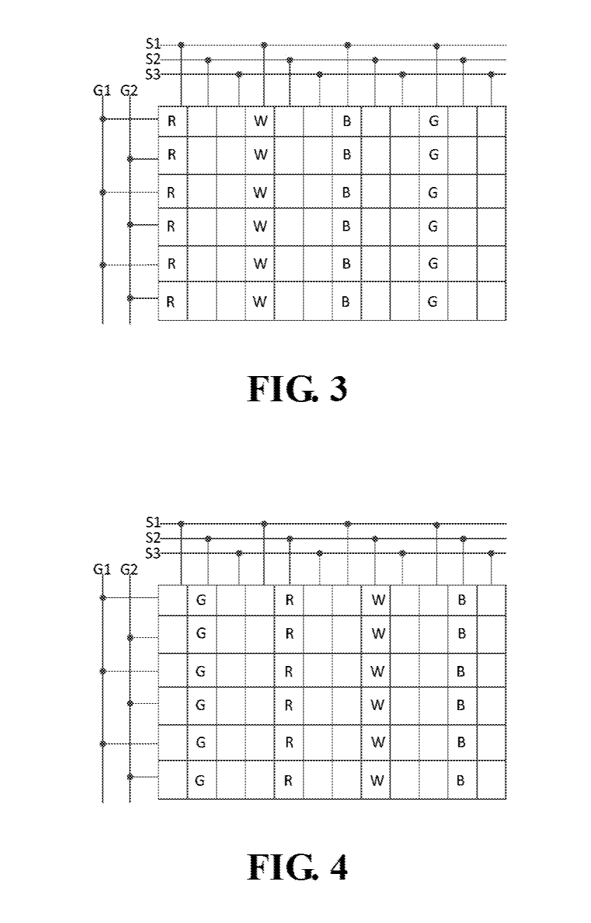

### DETAILED DESCRIPTION

Specific structure and function details disclosed herein are only representative and are used for the purpose of describing exemplary embodiments of the present application. However, the present application may be specifically achieved in many alternative forms and shall not be interpreted to be only limited to the embodiments described herein.

It should be understood in the description of the present application that terms such as “central”, “horizontal”, “upper”, “lower”, “left”, “right”, “vertical”, “horizontal”, “top”, “bottom”, “inner”, “outer”, etc. indicate direction or position relationships shown based on the drawings, and are only intended to facilitate the description of the present application and the simplification of the description rather than to indicate or imply that the indicated device or element must have a specific direction or constructed and operated in a specific direction, and therefore, shall not be understood as a limitation to the present application. In addition, the terms such as “first” and “second” are only used for the purpose of description, rather than being understood to indicate or imply relative importance or hint the number of indicated technical features. Thus, the feature limited by “first” and “second” can explicitly or impliedly include one or more features. In the description of the present application, the meaning of “a plurality of” is two or more unless otherwise specified. In addition, the term “include” and any variant are intended to cover non-exclusive inclusion.

It should be noted in the description of the present application that, unless otherwise specifically regulated and defined, terms such as “installation”, “bonded” and “bonding” shall be understood in broad sense, and for example, may refer to fixed bonding or detachable bonding or integral bonding, may refer to mechanical bonding or electrical bonding, and may refer to direct bonding or indirect bonding through an intermediate medium or inner communication of two elements. For those of ordinary skill in the art, the meanings of the above terms in the present application may be understood according to concrete conditions.

The terms used herein are intended to merely describe concrete embodiments, not to limit the exemplary embodiments. Unless otherwise noted clearly in the context, singular forms “one” and “single” used herein are also intended to include plurals. It should also be understood that the terms “include” and/or “include” used herein specify the existence of stated features, integers, steps, operation, units and/or assemblies, not excluding the existence or addition of one or more other features, integers, steps, operation, units, assemblies and/or combinations of these.

In the drawings, units with similar structures are expressed by same mark number.

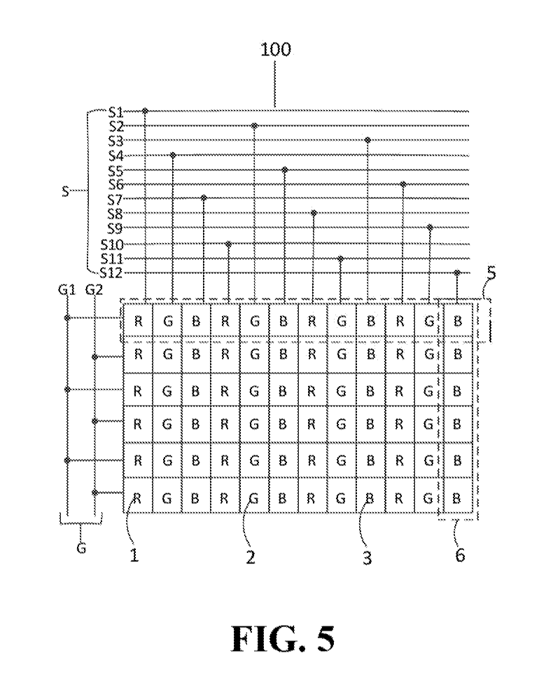

The test device and test method for a display panel of the present application are further described below in detail with reference to FIG. 5 to FIG. 9 and embodiments.

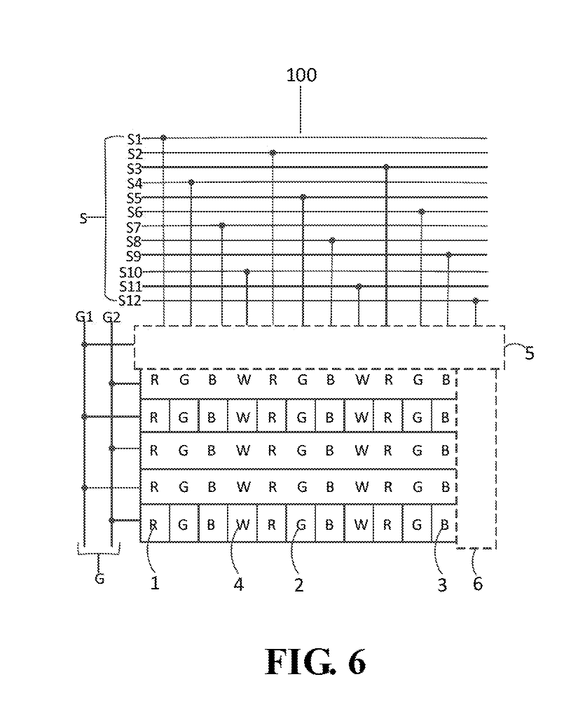

According to an embodiment of the present application, as shown in FIG. 5 and FIG. 6, FIG. 5 is one structural schematic diagram of a test device connected to RGB color filters in an embodiment of the present application, and FIG. 6 is one structural schematic diagram of a test device connected to WRGB color filters in an embodiment of the present application. RGB color filters represent red color filters, green color filters and blue color filters, and WRGB color filters represent white color filters, red color filters, green color filters and blue color filters.

The test device in an embodiment of the present application is used in the test for the display panel, specifically, used in the test for a picture of the display panel. The display panel may include a substrate and color filters arranged on the substrate. The color filters include a plurality of row color filters 5 and at least twelve column color filters 6, where the row color filters 5 and the column color filters 6 are perpendicular to each other.

The display panel may include any of the following: a twisted nematic (TN) or a super twisted nematic (STN) type panel, an in-plane switching (IPS) type panel, a vertical alignment (VA) type panel, a high vertical alignment (HVA) type panel and a curved surface type panel.

The display panel may be used in a display device, where the display device may be an organic light-emitting diode (OLED) display apparatus.

The test device include data lines S and scanning lines G.

The scanning lines G are used to be connected to the row color filters 5, specifically, the scanning lines G include first scanning lines G1 and second scanning lines G2, where the first scanning lines G1 and the second scanning lines G2 are respectively connected to the row color filters alternately. That is to say, the first scanning lines G1 scan the row color filters 5 of the Nth row, N being greater than or equal to 1, and the second scanning lines G2 scan the row color filters 5 of the N+1th row and are connected thereto in sequence, to scan the color filters.

The data lines S are used to be connected to the column color filters 6, where a number of the data lines S is at least twelve, and each data line S is connected to one column color filter 6.

In the test device 100 for the display panel in an embodiment of the present application, a number of the column color filters 6 is a common multiple of three and four, for example, twelve, twenty four, forty eight and the like, and a number of the data lines S is the same as that of the column color filters 6. In an embodiment of the present application, a number of the data lines S is twelve, a number of the column color filters 6 is twelve, and the data lines S are connected to the column color filters 6 in a manner of one-to-one correspondence.

In the test device 100 for the display panel in an embodiment of the present application, the twelve data lines S are arranged in sequence. Specifically, the data lines S include a first data line S1, a second data line S2, a third data line S3, a fourth data line S4, a fifth data line S5, a sixth data line S6, a seventh data line S7, an eighth data line S8, a ninth data line S9, a tenth data line S10, an eleventh data line S11 and a twelfth data line S12. The data lines S are specifically arranged from top to bottom as follows: the first data line S1, the second data line S2, the third data line S3, the fourth data line S4, the fifth data line S5, the sixth data line S6, the seventh data line S7, the eighth data line S8, the ninth data line S9, the tenth data line S10, the eleventh data line S11 and the twelfth data line S12 respectively. Of course, it should be noted that the data lines may be arranged from bottom to top.

In the test device 100 for the display panel in an embodiment of the present application, the twelve column color filters 6 are arranged in sequence, and the twelve column color filters 6 are divided into three groups, each group of column color filters 6 including four adjacent column color filters 6. Specifically, for example, in FIG. 5, the four adjacent column color filters 6 from the left thereof are a red color filter, a green color filter, a blue color filter and a red color filter respectively. Specifically, for example, in FIG. 6, the four adjacent column color filters 6 from the left thereof are a red color filter, a green color filter, a blue color filter and a white color filter respectively.

In the test device 100 for the display panel in an embodiment of the present application, the four column color filters in the same group of column color filters are connected to the data line in sequence at an interval of two data lines. Specifically, for example, from the left group of column color filters in FIG. 6, the column color filters of the column including red color filters are connected to the first data line S1, then the column color filters of the column including green color filters are connected to the fourth data line S4 at an interval of two data lines (the second data line S2 and the third data line S3), and then the column color filters of the column including blue color filters are connected to the seventh data line S7 at an interval of two data lines (the fifth data line S5 and the sixth data line S6), and finally, the column color filters of the column including white color filters are connected to the tenth data line S10 an interval of two data lines (the eighth data line S8 and the ninth data line S9). The connecting manner of other groups of column color filters is the same as this connecting manner, see FIG. 5 and FIG. 6 for detail, which will not be described in detail herein.

This is one specific manner of connecting the data lines S to the column color filters 6 of the present application, and connecting in a grouping manner is less error prone and facilitates connecting operations. Of course, it should be noted that the manner of connecting the data lines S to the column color filters 6 in an embodiment of the present application is not limited thereto. Specifically:

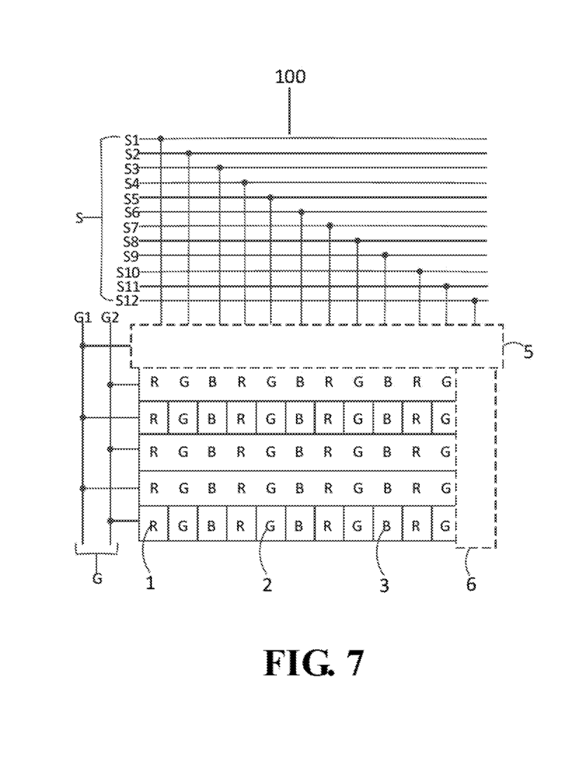

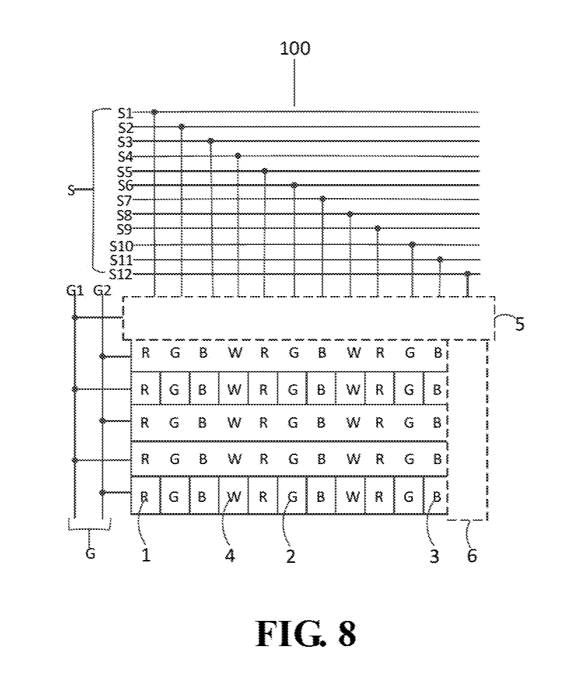

For example, as shown in FIG. 7 and FIG. 8, the twelve data lines S are connected to the twelve column color filters 6 in sequence from one end to the other end thereof, and from one side to the other side of the column color filters 6. Specifically, the first data line S1, the second data line S2, the third data line S3, the fourth data line S4, the fifth data line S5, the sixth data line S6, the seventh data line S7, the eighth data line S8, the ninth data line S9, the tenth data line S10, the eleventh data line S11 and the twelfth data line S12 are connected to the column color filters respectively from the left column color filter thereof.

Specifically, in FIG. 8, the first data line S1 is connected to the left column color filter 6. However, the data lines S, from the first data line S1, are connected to the column color filters 6 in sequence from the left column color filter to the right column color filter thereof, and the twelfth data line S12 is connected to the right column color filter 6. This is another specific manner of connecting the data lines S to the column color filters 6 of the present application, and connecting in sequence facilitates connecting operations and is less error prone.

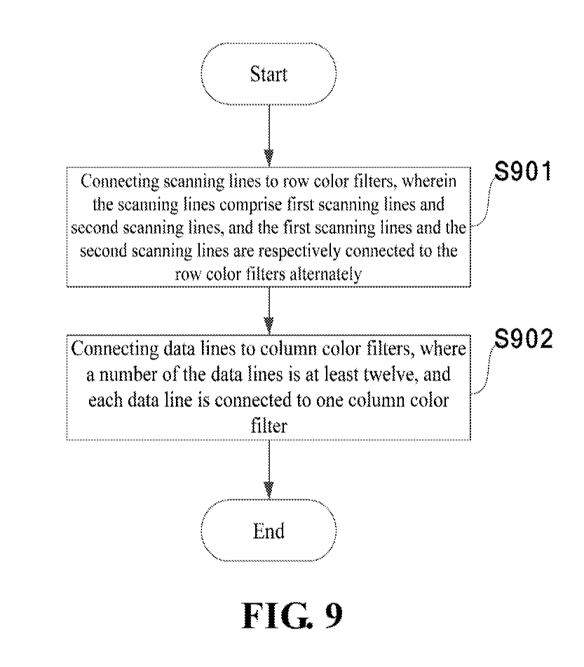

In an embodiment of the present application, as shown in FIG. 9, FIG. 9 is a flowchart of a test method for a display panel in an embodiment of the present application. The test method may be achieved through the above test device, also see FIG. 5 to FIG. 8. The test method in an embodiment of the present application is used in the test for the display panel, specifically, used in the test for a picture of the display panel. The display panel may include a substrate and color filters arranged on the substrate. The color filters include a plurality of row color filters 5 and at least twelve column color filters 6, where the row color filters 5 and the column color filters 6 are perpendicular to each other.

The display panel may be used in a display device, where the display device may be an organic light-emitting diode (OLED) display apparatus.

The test method include step S901 and step S902.

Step S901: connecting scanning lines to the row color filters, where the scanning lines include first scanning lines and second scanning lines, and the first scanning lines and the second scanning lines are respectively connected to the row color filters alternately.

Specifically, the scanning lines G are used to be connected to the row color filters 5. Specifically, the scanning lines G include first scanning lines G1 and second scanning lines G2, where the first scanning lines G1 and the second scanning lines G2 are respectively connected to the row color filters alternately. That is to say, the first scanning lines G1 scan the row color filters 5 of the Nth row, N being greater than or equal to 1, and the second scanning lines G2 scan the row color filters 5 of the N+1th row and are connected thereto in sequence, to scan the color filters.

Step S902: connecting data lines to the column color filters, where a number of the data lines is at least twelve, and each data line is connected to one column color filter.

The data lines S are used to be connected to the column color filters 6, where a number of the data lines S is at least twelve, and each data line S is connected to one column color filter 6.

In the test method for the display panel in an embodiment of the present application, a number of the column color filters 6 is a common multiple of three and four, for example, twelve, twenty four, forty eight and the like, and a number of the data lines S is the same as that of the column color filters 6. In an embodiment of the present application, a number of the data lines S is twelve, a number of the column color filters 6 is twelve, and the data lines S are connected to the column color filters 6 in a manner of one-to-one correspondence.

In the test method for the display panel in an embodiment of the present application, the twelve data lines S are arranged in sequence. Specifically, the data lines S include a first data line S1, a second data line S2, a third data line S3, a fourth data line S4, a fifth data line S5, a sixth data line S6, a seventh data line S7, an eighth data line S8, a ninth data line S9, a tenth data line S10, an eleventh data line S11 and a twelfth data line S12. The data lines S are specifically arranged from top to bottom as follows: the first data line S1, the second data line S2, the third data line S3, the fourth data line S4, the fifth data line S5, the sixth data line S6, the seventh data line S7, the eighth data line S8, the ninth data line S9, the tenth data line S10, the eleventh data line S11 and the twelfth data line S12 respectively. Of course, it should be noted that the data lines may be arranged from bottom to top.

In the test method for the display panel in an embodiment of the present application, the twelve column color filters 6 are arranged in sequence, and the twelve column color filters 6 are divided into three groups, each group of column color filters 6 including four adjacent column color filters 6. Specifically, for example, in FIG. 5, the four adjacent column color filters 6 from the left thereof are a red color filter, a green color filter, a blue color filter and a red color filter respectively. Specifically, for example, in FIG. 6, the four adjacent column color filters 6 from the left thereof are a red color filter, a green color filter, a blue color filter and a white color filter respectively.

In the test method for the display panel in an embodiment of the present application, the four column color filters in the same group of column color filters are connected to the data line in sequence at an interval of two data lines. Specifically, for example, from the left group of column color filters in FIG. 6, the column color filters of the column including red color filters are connected to the first data line S1, then the column color filters of the column including green color filters are connected to the fourth data line S4 at an interval of two data lines (the second data line S2 and the third data line S3), and then the column color filters of the column including blue color filters are connected to the seventh data line S7 at an interval of two data lines (the fifth data line S5 and the sixth data line S6), and finally, the column color filters of the column including white color filters are connected to the tenth data line S10 an interval of two data lines (the eighth data line S8 and the ninth data line S9). The connecting manner of other groups of column color filters is the same as this connecting manner, see FIG. 5 and FIG. 6 for detail, which will not be described in detail herein.

This is one specific manner of connecting the data lines S to the column color filters 6 of the present application, and connecting in a grouping manner is less error prone and facilitates connecting operations. Of course, it should be noted that the manner of connecting the data lines S to the column color filters 6 in an embodiment of the present application is not limited thereto. Specifically:

For example, as shown in FIG. 7 and FIG. 8, the twelve data lines S are connected to the twelve column color filters 6 in sequence from one end to the other end thereof, and from one side to the other side of the column color filters 6. Specifically, the first data line S1, the second data line S2, the third data line S3, the fourth data line S4, the fifth data line S5, the sixth data line S6, the seventh data line S7, the eighth data line S8, the ninth data line S9, the tenth data line S10, the eleventh data line S11 and the twelfth data line S12 are connected to the column color filters respectively from the left column color filter thereof.

Specifically, in FIG. 8, the first data line S1 is connected to the left column color filter 6. However, the data lines S, from the first data line S1, are connected to the column color filters 6 in sequence from the left column color filter to the right column color filter thereof, and the twelfth data line S12 is connected to the right column color filter 6. This is another specific manner of connecting the data lines S and column color filters 6 of the present application, and connecting in sequence facilitates connecting operations and is less error prone.

The above contents are further detailed descriptions of the present application in combination with specific embodiments. However, the concrete implementation of the present application shall not be considered to be only limited to these descriptions. For those of ordinary skill in the art to which the present application belongs, several simple deductions or replacements may be made without departing from the conception of the present application, all of which shall be considered to belong to the protection scope of the present application.

What is claimed is:

1. A test device for a display panel, the display panel comprising color filters including a plurality of row color filters and at least twelve column color filters, the test device comprising:
scanning lines, connected to the row color filters, wherein the scanning lines comprise first scanning lines and second scanning lines, and the first scanning lines and the second scanning lines are respectively connected to the row color filters alternately; and
data lines, connected to the column color filters, wherein a number of the data lines is at least twelve, and each data line is connected to one column color filter; a number of the data lines is twelve, a number of the column color filters is twelve, and the data lines are connected to the column color filters in a manner of one-to-one correspondence; a number of the column color filters is a common multiple of three and four, and a number of the data lines is the same as that of the column color filters;
the twelve column color filters are arranged in sequence, and the twelve column color filters are divided into three groups, each group of column color filters including four adjacent column color filters; the twelve data lines are arranged in sequence, and the four column color filters in the same group of column color filters are connected to the data line in sequence at an interval of two data lines; alternatively, the twelve data lines are arranged in sequence, the twelve column color filters are arranged in sequence, and the twelve data lines are connected to the twelve column color filters in sequence from one end to the other end thereof, and from one side to the other side of the column color filters.

2. A test device for a display panel, the display panel comprising color filters including a plurality of row color filters and at least twelve column color filters, the test device comprising:
scanning lines, connected to the row color filters, wherein the scanning lines comprise first scanning lines and second scanning lines, and the first scanning lines and the second scanning lines are respectively connected to the row color filters alternately; and
data lines, connected to the column color filters, wherein a number of the data lines is at least twelve, and each data line is connected to one column color filter.

3. The test device for the display panel according to claim 2, wherein a number of the data lines is twelve, a number of the column color filters is twelve, and the data lines are connected to the column color filters in a manner of one-to-one correspondence.

4. The test device for a display panel according to claim 3, wherein the twelve column color filters are arranged in sequence, and the twelve column color filters are divided into three groups, each group of column color filters including four adjacent column color filters; and the twelve data lines are arranged in sequence, and the four column color filters in the same group of column color filters are connected to the data line in sequence at an interval of two data lines.

5. (canceled)

6. Test device for a display panel according to claim 3, wherein the twelve data lines are arranged in sequence, the twelve column color filters are arranged in sequence, and the twelve data lines are connected to the twelve column color filters in sequence from one end to the other end thereof, and from one side to the other side of the column color filters.

7. (canceled)

8. (canceled)

9. The test device for a display panel according to claim 2, wherein a number of the data lines is twelve, a number of the column color filters is twelve, and the data lines are connected to the column color filters in a manner of one-to-one correspondence; and a number of the column color filters is a common multiple of three and four, and a number of the data lines is the same as that of the column color filters.

10. The test device for a display panel according to claim 2, wherein a number of the data lines is twelve, a number of the column color filters is twelve, and the data lines are connected to the column color filters in a manner of one-to-one correspondence; and the twelve column color filters are arranged in sequence, and the twelve column color filters are divided into three groups, each group of column color filters including four adjacent column color filters; and the twelve data lines are arranged in sequence, and the four column color filters in the same group of column color filters are connected to the data line in sequence at an interval of two data lines; and a number of the column color filters is a common multiple of three and four, and a number of the data lines is the same as that of the column color filters.

11. (canceled)

12. A test method for a display panel, wherein the display panel comprises color filters including a plurality of row color filters and at least twelve column color filters, and the test method comprises:
Connecting scanning lines to the row color filters, wherein the scanning lines comprise first scanning lines and second scanning lines, and the first scanning lines and the second scanning lines are respectively connected to the row color filters alternately; and
connecting the data lines to the column color filters, wherein a number of the data lines is at least twelve, and each data line is connected to one column color filter.

13. The test method for a display panel according to claim 12, wherein a number of the data lines is twelve, a number of the column color filters is twelve, and the data lines are connected to the column color filters in a manner of one-to-one correspondence.

14. The test method for a display panel according to claim 13, wherein the twelve column color filters are arranged in sequence, and the twelve column color filters are divided into three groups, each group of column color filters including four adjacent column color filters; and the twelve data lines are arranged in sequence, and the four column color filters in the same group of column color filters are connected the data lines in sequence at an interval of two data lines.

15. (canceled)

16. The test method for a display panel according to claim 13, wherein the twelve data lines are arranged in sequence, the twelve column color filters are arranged in sequence, and the twelve data lines are connected to the twelve column color filters in sequence from one end to the other end thereof, and from one side to the other side of the column color filters.

17. (canceled)

18. The test method for a display panel according to claim 12, wherein a number of the column color filters is a common multiple of three and four, and a number of the data lines is the same as that of the column color filters.

19. (canceled)

20. (canceled)

21. The test device for a display panel according to claim 4, wherein the twelve data lines are arranged in sequence, the twelve column color filters are arranged in sequence, and the twelve data lines are connected to the twelve column color filters in sequence from one end to the other end thereof, and from one side to the other side of the column color filters.

22. The test device for a display panel according to claim 4, wherein the four adjacent column color filters from the left thereof are a red color filter, a green color filter, a blue color filter and a red color filter respectively.

23. The test device for a display panel according to claim 4, wherein the four adjacent column color filters from the left thereof are a red color filter, a green color filter, a blue color filter and a white color filter respectively.

24. The test device for a display panel according to claim 22, wherein the data line comprises a first data line, a second data line, a third data line, a fourth data line, a fifth data line, a sixth data line, a seventh data line, an eighth data line, a ninth data line, a tenth data line, an eleventh data line, and a twelfth data line;
wherein, the red color filter is connected to the first data line, the sixth data line, the eighth data line, and the tenth data line;
the green color filter is connected to the second data line, the fourth data line, the ninth data line, and the eleventh data line; and
the blue color filter is connected to the third data line, the fifth data line, the seventh data line, and the twelfth data line.

25. The test device for a display panel according to claim 23, wherein the data line comprises a first data line, a second data line, a third data line, a fourth data line, a fifth data line, a sixth data line, a seventh data line, an eighth data line, a ninth data line, a tenth data line, an eleventh data line, and a twelfth data line;
wherein, the red color filter is connected to the first data line, the second data line, and the third data line;
the green color filter is connected to the fourth data line, the fifth data line, and the sixth data line;
the blue color filter is connected to the seventh data line, the eighth data line, and the ninth data line;
the white color filter is connected to the tenth data line, the eleventh data line, and the twelfth data line.
